(19) United States
(12) Patent Application Publication
(10) Pub. No.: US 2011/0199448 A1
(43) Pub. Date: Aug. 18, 2011

(54) IMAGE FORMING APPARATUS AND DRYING METHOD IN IMAGE FORMING APPARATUS

(75) Inventors: Satoshi Kaiho, Kanagawa-ken (JP); Satoshi Kinouchi, Tokyo-to (JP); Nobuaki Takahashi, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/024,492

(22) Filed: Feb. 10, 2011

Related U.S. Application Data
(60) Provisional application No. 61/305,385, filed on Feb. 17, 2010.

(51) Int. Cl. B41J 2/01

(52) U.S. Cl. 347/102

(57) ABSTRACT

According to one embodiment, an image forming apparatus includes an image forming unit, a tray, a heating mechanism, a blower, and a body casing. The image forming unit forms an image on an image forming medium. The tray stacks the image forming medium, having an image formed thereon by the image forming unit, on the tray. The heating mechanism warms air. The blower sends out the air warmed by the heating mechanism. The body casing has a discharge opening. The discharge opening is used to discharge the air sent from the blower to the image forming medium stacked on the tray.

### CROSS-REFERENCE TO RELATED APPLICATIONS

This application is based upon and claims the benefit of priority from U.S. Provisional Application No. 61/305,385 filed on Feb. 17, 2010; the entire contents of which are incorporated herein by reference.

### FIELD

Embodiments described herein relate generally to an image forming apparatus and a drying method in the image forming apparatus.

### BACKGROUND

For example, in an ink jet type image forming apparatus, curling or cockling easily occurs in paper to which ink is discharged. Both now and in the past, in many cases, the ink jet type image forming apparatus has a configuration in which the paper is dried while the paper is carried. However, the paper to which a large amount of ink is applied needs to be dried for a long period of time. In order to reliably dry the ink on the paper when the amount of ink is large, there is a tendency that the image forming apparatus increases in size, becomes complicated, or requires more consumption of power.

### BRIEF DESCRIPTION OF THE DRAWINGS

FIG. 1 is a diagram schematically illustrating a configuration example of an image forming apparatus.

FIG. 2 is a side view illustrating a configuration example of the periphery of an image forming unit.

FIG. 3 is a diagram illustrating a configuration example of a drying mechanism in the image forming apparatus.

FIG. 4 is a block diagram illustrating a configuration example of a control system in the image forming apparatus.

FIG. 5 is a flowchart illustrating image forming in the image forming apparatus.

FIG. 6 is a flowchart illustrating drying in the image forming apparatus.

### DETAILED DESCRIPTION

In general, according to one embodiment, an image forming apparatus includes an image forming unit, a tray, a heating mechanism, a blower, and a body casing. The image forming unit forms an image on an image forming medium. The tray stacks the image forming medium having an image formed thereon by the image forming unit thereon. The heating mechanism warms air. The blower sends out the air warmed by the heating mechanism. The body casing has a discharge opening. The discharge opening is used to discharge the air sent from the blower to the image forming medium stacked on the tray.

Hereinafter, an exemplary embodiment will be described by referring to the drawings.

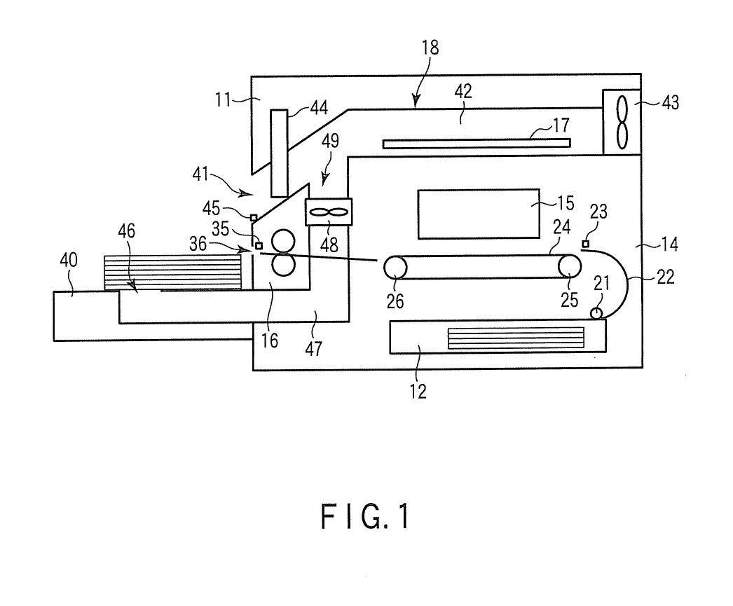

FIG. 1 is a diagram illustrating a configuration example of an image forming apparatus.

The image forming apparatus includes an image forming apparatus body and a discharge tray 40. The image forming apparatus body includes a body casing 11, a medium accommodation unit 12, a medium supplying-carrying unit 14, an image forming unit 15, a medium discharge unit 16, a system control unit 17, a duct 18, and the like.

The body casing 11 is used to accommodate and dispose the respective components therein. The medium accommodation unit 12 includes a cassette that accommodates paper as an image forming medium. The medium supplying-carrying unit 14 takes out the paper as the image forming medium from the medium accommodation unit 12. The medium supplying-carrying unit 14 includes a paper feeding roller 21 which is installed at the paper extraction opening of the cassette. The medium supplying-carrying unit 14 takes out the pieces of paper one by one from the medium accommodation unit 12. The medium supplying-carrying unit 14 includes a paper feeding roller 21 which is installed at the paper extraction opening of the cassette. Further, the medium supplying-carrying unit 14 includes a carrying path 22, a carrying belt 24, a driving roller 25, and a driven roller 26. The medium supplying-carrying unit 14 takes out the pieces of paper as the image forming medium one by one from the medium accommodation unit 12. The carrying path 22 guides the paper supplied from the medium supplying-carrying unit 14 to the carrying belt 24. The carrying path 22 includes a paper sensor 23 which detects the paper supplied to the carrying belt 24. The carrying belt 24 is suspended on the driving roller 25 and the driven roller 26. The driving roller 25 and the driven roller 26 support the carrying belt 24 by applying a predetermined tension thereto. The driving roller 25 is rotated by a driving force transmitted from a driving unit such as a motor. The carrying belt 24 is driven by the rotation of the driving roller 25. The driven roller 26 is rotated in accordance with the movement of the carrying belt 24 driven by the driving roller 25. The carrying belt 24 carries the paper while maintaining the posture of the paper in a plane shape in the position where the image is formed by the image forming unit 15.

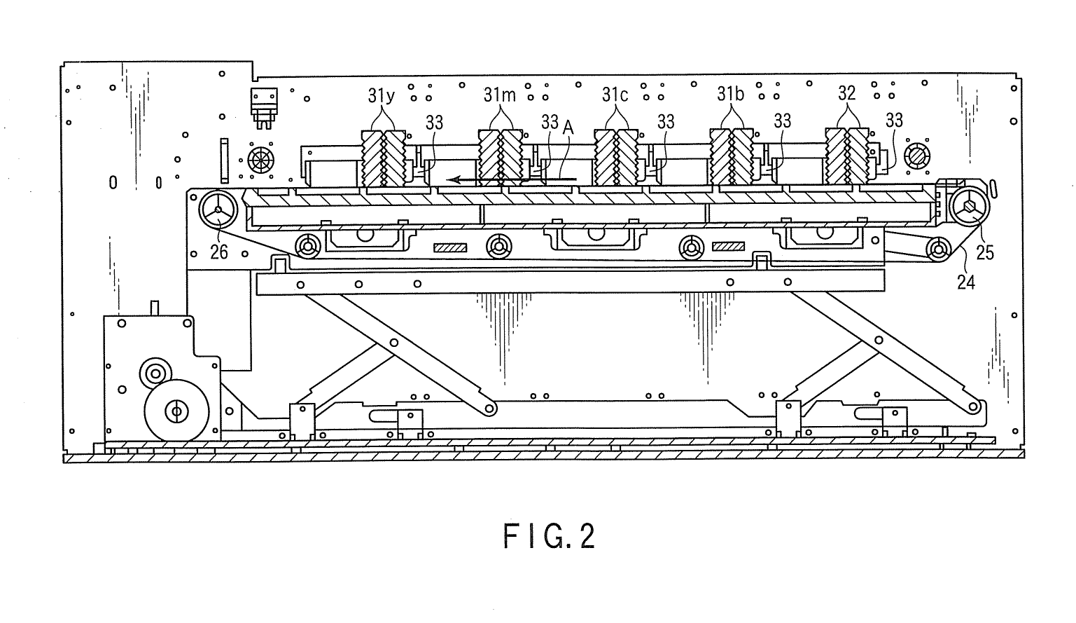

FIG. 2 is a side view illustrating a configuration example of the periphery of the image forming unit 15.

The image forming unit 15 includes plural recording heads 31. In the image forming unit 15 of the embodiment, each recording head 31 is formed as an ink jet head. The number of the recording heads 31 is decided depending on the image forming range, the resolution, and the number of colors. The image forming unit 15 includes a preprocessing fluid head 32.

In the configuration example shown in FIG. 2, the image forming unit 15 includes four colors of recording heads 31b, 31c, 31m, and 31y which are the recording heads 31. The plural recording heads 31b, 31c, 31m, and 31y are sequentially disposed from the upstream to the downstream in parallel at a predetermined interval in the paper carrying direction A of the carrying belt 24. The recording heads 31b, 31c, 31m, and 31y include plural discharge holes which are provided to face the paper carried by the carrying belt 24 and a discharge mechanism which discharges ink from the discharge holes. The recording heads 31b, 31c, 31m, and 31y respectively discharge each color (for example, black (B), cyan (C), magenta (M), and yellow (Y)) of ink from the discharge holes. The recording heads 31 form an image on the surface of the paper that is carried while facing the discharge holes by using the ink discharged from the respective discharge holes in accordance with image data.

The preprocessing fluid head 32 is disposed at the upstream of the carrying direction A of the plural recording heads 31. The preprocessing fluid head 32 applies a preprocessing liquid onto an image forming surface of the paper as the image forming medium. The preprocessing liquid applied by the preprocessing fluid head 32 is used to shorten the time of fixing the ink to the surface of the paper as the image forming medium. That is, the image forming unit 15 forms an image on the paper surface applied with the preprocessing liquid by using the respective colors of inks.

In the image forming unit 15, a paper sensor 33 is installed at the upstream of each of the recording heads 31 and the preprocessing fluid head 32 in the carrying direction A. Each paper sensor 33 detects the paper as the image forming medium that is carried by the carrying belt 24. On the basis of the timing at which the paper is detected by the paper sensor 33, the timing of driving each recording head 31 and the preprocessing fluid head 32 is controlled.

Next, the configuration of a mechanism discharging the image forming medium having an image formed thereon will be described.

The paper as the image forming medium having an image formed thereon by the image forming unit 15 is discharged to a paper discharge tray 40 by a medium discharge unit 16. The carrying belt 24 carries the paper having an image formed thereon to the medium discharge unit 16. The medium discharge unit 16 includes a carrying roller and the like. The medium discharge unit 16 discharges the paper having an image formed thereon from a discharge opening 36 to the paper discharge tray 40. The discharge opening 36 includes a paper sensor 35 which detects the paper discharged to the paper discharge tray 40. The paper discharge tray 40 is provided at the outside of the body casing 11 of the image forming apparatus body. The paper discharge tray 40 is a stacker that stacks the paper having an image formed thereon.

Next, a mechanism drying the image forming medium having an image formed thereon will be described.

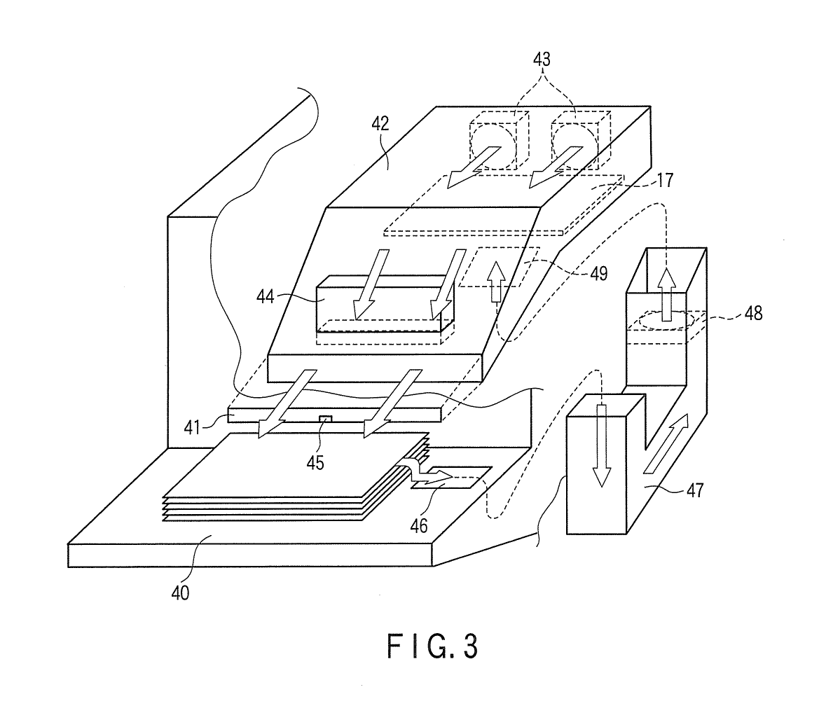

FIG. 3 is a diagram illustrating a configuration example of the drying mechanism in the image forming apparatus. In FIG. 3, the air stream is depicted by the arrow. As shown in FIG. 3, a discharge opening 41 is provided in the vicinity of the paper discharge tray 40 so that air contacting the paper having an image formed thereon is discharged therethrough. The discharge opening 41 discharges a warm air stream used for drying the ink on the image forming surface of the paper as the image forming medium. The discharge opening 41 is provided at the side of the surface having an image with respect to the pieces of paper stacked on the paper discharge tray 40. That is, the discharge opening 41 is formed so that the air discharged from the discharge opening contacts the image forming surface of the paper as the image forming medium. Further, even in the configuration in which the paper having an image formed thereon is stacked in the body casing 11, the discharge opening 41 may be provided so that the drying warm air stream contacts the image forming surface of the pieces of stacked paper.

A duct 42 is connected to the discharge opening 41. A warm air stream (drying warm air stream) is heated up to a drying temperature by heating air in the duct 42 and is discharged from the discharge opening 41. A fan (cooling fan) 43 is provided inside the duct 42. The fan 43 serves as a blower, and causes an air stream inside the duct 42. That is, the fan 43 is provided furthest upstream of the air passage in the duct 42. The air sent from the fan 43 is discharged from the discharge opening 41 through the duct 42. The system control unit 17 is installed at a position contacting the air sent from the fan 43 inside the duct 42. Further, in the passage of the air sent from the fan 43 inside the duct 42, a heating mechanism 44 heating air is installed in front of the discharge opening 41 which is at the downstream of the system control unit 17. The heating mechanism 44 includes a heater (not shown).

That is, the fan 43 has a function serving as a cooling fan that sends air used for cooling the system control unit 17 and a function of blowing warm air stream warmed by the heating mechanism from the discharge opening 41. The air sent from the fan 43 is heated by the heating mechanism 44 after contacting the system control unit 17, and is discharged from a discharge opening 41. With such a configuration, the air sent from the fan 43 inside the duct 42 is warmed by the thermal energy of the system control unit 17, and the warm air (the air after cooling the system control unit) is supplied to the heating mechanism 44.

The heating mechanism 44 generates heat and warms air by giving thermal energy to the air. The heating mechanism 44 may be controlled by the system control unit 17, and a mechanism capable of increasing the temperature of the air may be used. For example, the heating mechanism 44 is formed of a heater capable of controlling the amount of generated heat. The discharge opening 41 is provided with a temperature sensor 45. The amount of heat (the amount of heat given to the air) generated by the heating mechanism 44 is controlled on the basis of the temperature detected by the temperature sensor 45 (the temperature of the air discharged from the discharge opening 41). With such a configuration, the air discharged from the discharge opening 41 may be controlled at the set temperature.

Further, a part of a suction hole 46 and a reflux duct 47 is provided in the paper discharge tray 40. The suction hole 46 is a hole that sucks air in the periphery of the paper discharge tray 40. The suction hole 46 is connected to a reflux duct 47 that makes the sucked air flow backward into the duct 42. A hole provided at the opposite side of the suction hole 46, provided at one end side of the reflux duct 47 provided in the paper discharge tray 40, is connected to a hole provided in the body casing 11. The suction hole 46 is located at a position not overlapping with the discharge opening 41 in the direction perpendicular to the carrying direction of the medium with respect to the discharge opening 41. Therefore, the medium discharged from the discharge opening 41 does not block the suction hole 46. The suction hole 46 may be formed in any shape if the suction hole guides the air in the periphery of the paper discharge tray 40 including the air discharged from the discharge opening 41 to the reflux duct 47.

A fan (suction fan) 48 is provided inside the reflux duct 47 inside the image forming apparatus body. The fan 48 sucks air from the suction hole 46, and sends the sucked air to the duct 42. The reflux duct 47 is connected to a merging hole 49 provided in the duct 42. The merging hole 49 is provided between the system control unit 17 and the heating mechanism 44.

As described above, the image forming apparatus blows drying air to the image forming surface of the paper as the image forming medium having an image formed thereon and being stacked on the tray. The drying air is obtained by allowing the heating mechanism to heat the air used to cool the system control unit. Further, the air blown to the paper on the paper discharge tray is sucked and made to flow backward to the heating mechanism. With such a configuration, according to the image forming apparatus of the embodiment, the ink of the paper having an image formed thereon and stacked on the paper discharge tray may be effectively dried, and an increase in the amount of heat and consumption of power used to heat the air by the heating mechanism may be suppressed.

Next, the configuration of a control system of the image forming apparatus will be described.

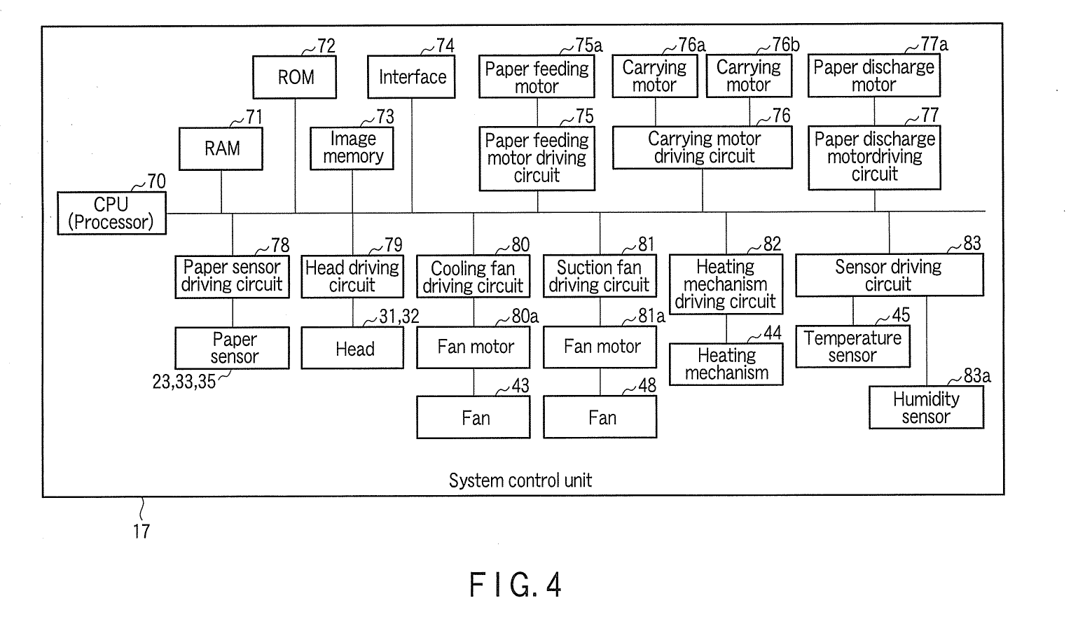

FIG. 4 is a block diagram illustrating a configuration example of the control system in the image forming apparatus.

The image forming apparatus includes a CPU (processor) 70, a RAM 71, a ROM 72, an image memory 73, an interface 74, a paper feeding motor driving circuit 75, a carrying motor driving circuit 76, a paper discharge motor driving circuit 77, a paper sensor driving circuit 78, a head driving circuit 79, a paper discharge motor driving circuit 77, a suction fan driving circuit 81, a heating mechanism driving circuit 82, and a sensor driving circuit 83. The system control unit 17 is formed of a substrate having a processor, a memory, and the like installed thereon. The system control unit 17 is installed so that the air stream generated by the cooling fan 43 contacts a member on the substrate (control substrate) necessary to be cooled in the image forming apparatus. For example, the system control unit 17 is installed so that the air stream generated by the cooling fan 43 contacts the CPU 70 on the control substrate. Further, the air stream generated by the cooling fan 43 may be made to contact the entire control substrate as the system control unit 17.

The CPU 70 is a processor that controls the entire image forming apparatus. The CPU 70 executes control and data processing of the respective units. The CPU 70 realizes the control and data processing of the respective units by executing a program stored in a non-volatile memory such as a ROM 72 by using the RAM 71. For example, the CPU 70 outputs a control signal used to control the respective units in accordance with the program. Further, the CPU 70 is connected to a display unit that displays guide information for a user and an operation panel that includes an operation button used to input an operation command from the user. The RAM 71 functions as a working memory. The ROM 72 is a non-volatile memory that stores a control program and control data. The image memory 73 is a memory that stores image data. The image memory 73 is, for example, a page memory or a hard disk drive.

The interface 74 is an interface that is used to be connected to an external device. For example, the interface 74 is a network interface that is connected to an external device through a network. Further, the interface 74 may be an interface that is locally connected to an external storage device or a memory card. The interface 74 may be connected to a scanner that acquires image data.

The paper feeding motor driving circuit 75 drives a paper feeding motor 75a. The paper feeding motor 75a is connected to the paper feeding roller 21. The paper feeding motor 75a is a motor that rotates the paper feeding roller 21. The paper feeding motor driving circuit 75 drives the paper feeding motor 75a in response to a driving command from the CPU 70. If the paper feeding roller 21 is rotated by the paper feeding motor 75a, the paper is taken out from the cassette 12. The paper taken out by the paper feeding roller 21 is supplied to the carrying path 22.

The carrying motor driving circuit 76 drives the carrying path 22 and the carrying belt 24. The carrying motor driving circuit 76 drives a carrying motor 76a that is connected to a carrying roller provided in the carrying path 22 and a carrying motor 76b that rotates the driving roller 25. The carrying motor driving circuit 76 drives the carrying motors 76a and 76b in response to a driving command from the CPU 70. For example, the CPU 70 drives the carrying motors 76a and 76b so that the paper is carried to the image forming position at a desired timing.

The paper discharge motor driving circuit 77 drives the medium discharge unit 16. The paper discharge motor driving circuit 77 drives a paper discharge motor 77a that is connected to a discharge roller (carrying roller) provided in the medium discharge unit 16. The paper discharge motor 77a is a motor that rotationally drives the discharge roller. The paper discharge motor driving circuit 77 drives the paper discharge motor 77a in response to a driving command from the CPU 70. If the discharge roller inside the medium discharge unit 16 is rotated by the paper discharge motor 77a, an image is formed by the image forming unit 15, and the paper carried by the carrying belt 24 is discharged to the paper discharge tray 40.

The paper sensor driving circuit 78 drives the paper sensors 23, 33, and 35 provided in the respective units inside the image forming apparatus. The paper sensor driving circuit 78 outputs a detection result of the paper sensors 23, 33, and 35 to the CPU 70. The CPU 70 controls the respective units in accordance with the detection results of the paper sensors 23, 33, and 35 provided in the respective units inside the image forming apparatus. For example, the CPU 70 determines the timing at which the ink is discharged from each recording head 31 to the paper on the basis of the detection result of each paper sensor 33 installed at the upstream in the carrying direction of each recording head 31.

The head driving circuit 79 drives the heads 31 and 32 which are provided in the image forming unit 15. The head driving circuit 79 drives the heads 31 and 32 in response to a driving command from the CPU 70. For example, when the CPU 70 controls the head driving circuit 79 at the timing based on the carrying timing of the paper in accordance with image data used for image forming, the head driving circuit 79 drives the respective heads 31 and 32.

The cooling fan driving circuit 80 drives a fan motor 80a that rotates the fan (cooling fan) 43. The cooling fan driving circuit 80 drives the fan motor 80a rotating the fan 43 in response to a driving command from the CPU 70. That is, when the CPU 70 rotates the fan 43 by using the cooling fan driving circuit 80, the cooling of the system control unit 17 and the air stream of the duct 42 are controlled.

The suction fan driving circuit 81 drives a fan motor 81a that rotates the fan 48 as the suction fan. The suction fan driving circuit 81 drives the fan motor 81a rotating the suction fan 48 in response to a driving command from the CPU 70. That is, when the CPU 70 controls the rotation of the suction fan 48 by using the suction fan driving circuit 81, the air stream is controlled so that the air sucked from the suction hole 46 is made to flow backward to the duct 42 through the reflux duct 47.

The heating mechanism driving circuit 82 drives the heating mechanism 44 such as a heater used for heating the air discharged from the discharge opening 41. The heating mechanism driving circuit 82 may control the amount of heat given to the air discharged from the discharge opening 41. The heating mechanism driving circuit 82 generates heat given to the air discharged from the discharge opening 41 by driving the heating mechanism 44 in response to a driving command from the CPU 70. The heating mechanism driving circuit 82 controls the amount of heat generated by the heating mechanism 44 so that the temperature of the air detected by the temperature sensor 45 (the air discharged from the discharge opening 41) becomes equal to the temperature set by the CPU 70.

The sensor driving circuit 83 drives the temperature sensor 45 and a humidity sensor 83a. The temperature sensor 45 and the humidity sensor 83a are sensors that respectively detect the temperature and the humidity of the air discharged from the discharge opening 41. The sensor 45 installed in the discharge opening 41 may be a temperature humidity sensor. The sensor driving circuit 83 outputs the detection result of the temperature sensor 45 and the humidity sensor 83a to the CPU 70. For example, the CPU 70 controls the respective units of the drying mechanism in accordance with the temperature and the humidity of the air detected by the temperature sensor 45 and the humidity sensor 83a.

Next, the image forming procedure of the image forming apparatus will be described.

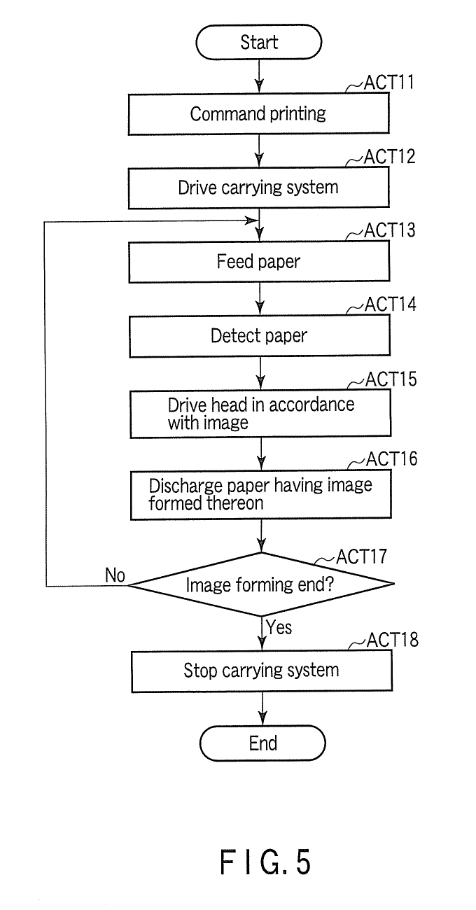

FIG. 5 is a flowchart illustrating image forming in the image forming apparatus.

The CPU 70 receives a command of forming an image on the paper as the image forming medium in accordance with an image forming command input from the operation panel or from the external device through the network (ACT 11). If the image forming command is received, the CPU 70 drives a carrying system that carries the paper as the image forming medium (ACT 12). That is, the CPU 70 drives the carrying motors 76a and 76b by using the carrying motor driving circuit 76. The carrying motor 76a rotates the carrying roller in the carrying path 22, and the carrying motor 76b rotates the driving roller 25, whereby the carrying belt 24 is driven.

If the carrying system is driven, the CPU 70 drives the paper feeding system that feeds the paper as the image forming medium (ACT 13). That is, when the carrying path 22 and the carrying belt 24 are driven, the CPU 70 drives the paper feeding motor 75a by using the paper feeding motor driving circuit 75. The paper feeding motor 75a rotates the paper feeding roller 21. The paper feeding roller 21 picks up the paper as the image forming medium from the cassette 12, and supplies the paper to the carrying path 22. The carrying path 22 supplies the paper supplied from the cassette 12 to the carrying belt 24. The paper arriving at the carrying belt 24 is absorbed to the carrying belt 24, and is carried while being adhered to the carrying belt 24.

If the paper is fed, the CPU 70 drives the respective paper sensors 23, 33, and 35 by using the paper sensor driving circuit 78. Each paper sensor 33 provided in the image forming unit 15 detects the paper carried by the carrying belt 24 (ACT 14). If the paper passes through the detection position, each paper sensor 33 transmits a detection signal representing the detection of the paper to the CPU 70. The CPU 70 decides the timing of driving the heads 31 and 32 on the basis of the detection signal from each paper sensor 33. That is, the CPU 70 determines the position of the paper on the basis of the time elapsed from the time point at which the paper sensor 33 detects the paper.

At the timing when it is determined that the paper arrives at a desired position on the basis of the detection signal of the paper sensor 33, the CPU 70 drives the heads 31 and 32. The CPU 70 drives each head 31 in accordance with the image data to be used to form an image on the paper. Each head 31 discharges each color of ink in accordance with the control signal from the CPU 70, and forms an image on one surface of the paper as the image forming medium (ACT 15).

Further, the CPU 70 drives the medium discharge unit 16 by driving the paper discharge motor 77a using the paper discharge motor driving circuit 77. The paper having an image formed thereon by the image forming unit 15 is carried by the carrying belt 24, and is peeled from the carrying belt 24 before the medium discharge unit 16 due to the curvature of the driven roller 26. The paper peeled from the carrying belt 24 is supplied to the medium discharge unit 16. The medium discharge unit 16 discharges the paper having an image formed thereon from the discharge opening 36 to the paper discharge tray 40 by carrying the paper using a carrying roller and the like (ACT 16).

The CPU 70 detects that the paper having an image formed thereon is discharged from the discharge opening 36 to the paper discharge tray 40 on the basis of the detection signal of the paper sensor 35. Through the processes of ACTs 13 to 16, image forming for one piece of paper is completed. The CPU 70 determines whether a desired number of pieces of image forming paper is obtained (ACT 18). If the CPU 70 determines that the desired number of pieces of image forming paper is not obtained, the process is performed again from ACT 13 until the desired number of pieces of image forming paper is obtained. If image forming for the total number of pieces of paper is completed (YES of ACT 17), the CPU 70 stops the carrying system by stopping the carrying motor driving circuit 76, the paper discharge motor driving circuit 77, and the like (ACT 18).

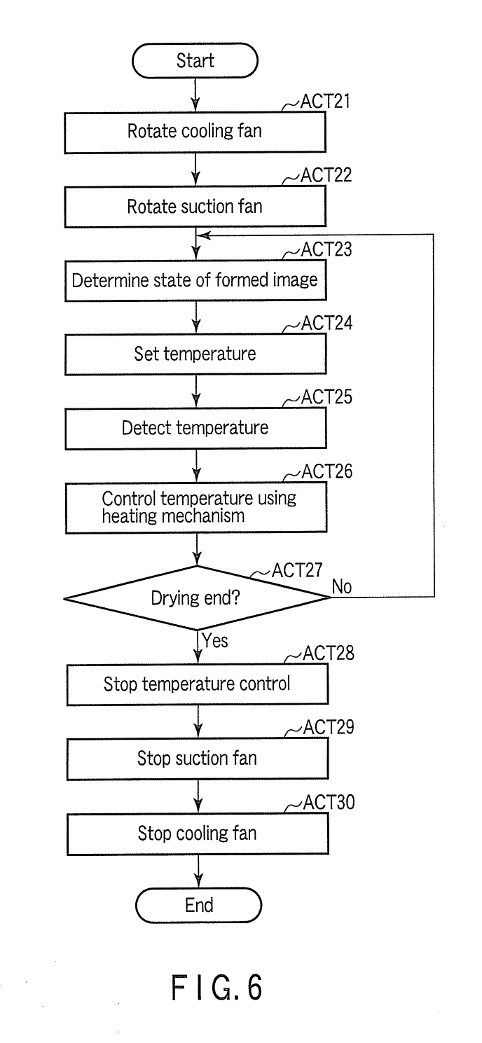

On the other hand, the CPU 70 controls the drying mechanism at the same time when the above-described image forming is performed or controls the drying mechanism before the above-described image forming is performed (ACTs 21 to 30). The drying will be described by referring to FIG. 6.

First, the CPU 70 rotates the cooling fan 43 by driving the fan motor 80a using the cooling fan driving circuit 80 (ACT 21). For example, the CPU 70 rotates the cooling fan 43 at the timing when the image forming starts or the timing when the image forming starts to be prepared.

However, the cooling fan 43 has a function of cooling the system control unit 17 as well as a function of blowing drying air. For this reason, the CPU 70 may normally drive the cooling fan 43 when the image forming apparatus is turned on. Further, when the image forming is not performed or the paper having an image formed thereon does not need to be dried, the CPU 70 may control the rotation of the cooling fan 43 in accordance with the operation state (for example, consumption of power, an ambient temperature, or an operation rate of a processor or the like) of the system control unit 17.

The CPU 70 also rotates the suction fan 48 by driving the fan motor 81a using the suction fan driving circuit 81 (ACT 22). For example, the CPU 70 rotates the suction fan 48 at the timing when the image forming starts or the image forming starts to be prepared.

If the image data for image forming is obtained, the CPU 70 determines the temperature of the drying air blown to the paper having an image formed thereon (the air discharged from the discharge opening 41) in accordance with the state of the image to be formed on the paper as the image forming medium (the amount of ink used to print the image on the paper) (ACT 23). For example, the CPU 70 may decide the temperature of the drying air blown to the paper having an image formed thereon in accordance with the amount of ink discharged to the paper as the image forming medium.

Further, the CPU 70 may decide the temperature of the drying air on the basis of the density of the image formed on the paper as the image forming medium. This may be realized by storing the temperature of the drying air corresponding to the density of the image printed on the paper in a non-volatile memory such as the ROM 72. That is, the CPU 70 may decide the density of the image to be printed on the paper by ink, and may decide the temperature of the air on the basis of the density of the image.

Further, the CPU 70 may decide the temperature of the drying air on the basis of the area (printing area) of the image formed on the paper as the image forming medium. This may be realized by storing the temperature of the drying air corresponding to the area of the image to be printed in a non-volatile memory such as the ROM 72. That is, the CPU 70 may decide the area of the image to be printed on the paper by ink, and may decide the temperature of the air on the basis of the decided area of the image.

If the temperature of the drying air is decided, the CPU 70 sets the decided temperature as a control target of the temperature of the drying air discharged from the discharge opening 41 (ACT 24). If the control target for the temperature of the drying air is set, the CPU 70 drives the temperature sensor 45 by using the sensor driving circuit 83. The temperature sensor 45 detects the temperature of the drying air discharged from the discharge opening 41, and outputs a detection signal representing the detected temperature to the CPU 70 (ACT 25).

The CPU 70 controls the temperature of the drying air so as to be equal to the set control target temperature by driving the heating mechanism 44 using the heating mechanism driving circuit 82 (ACT 26). That is, the CPU 70 controls the temperature of the drying air by driving the heating mechanism 44 in accordance with the detected temperature received from the temperature sensor 45 and the set control target temperature.

Further, the CPU 70 determines whether the drying is continuously performed on the basis of whether a predetermined time (drying time for the final paper) has elapsed from the time point when the final paper having an image formed thereon is discharged to the paper discharge tray 40 (ACT 27). If the drying ends (YES of ACT 27), the CPU 70 stops the temperature control by stopping the supply of power to the heating mechanism 44 using the heating mechanism driving circuit 82 (ACT 28).

If the drying ends, the CPU 70 stops the suction fan 48 by stopping the fan motor 81a using the suction fan driving circuit 81 (ACT 29). Further, the CPU 70 stops the cooling fan 43 by stopping the fan motor 80a using the cooling fan driving circuit 80 (ACT 29). However, as described above, the cooling fan 43 has a function of cooling the system control unit 17 as well as a function of blowing the drying air. For this reason, after the image forming, the CPU 70 may allow the cooling fan 43 to rotate to cool the system control unit 17 even when the paper having an image formed thereon does not need to be dried.

As described above, the image forming apparatus of the embodiment may blow the drying air warmed at a desired temperature to the image forming medium stacked on the paper discharge tray (stacker) after the image forming. As a result, according to the embodiment, it is not necessary to provide a mechanism for drying the image forming medium having an image formed thereon in the casing when the medium is carried, and the apparatus may be prevented from being increased in size and being complicated in structure.

Further, the image forming apparatus of the embodiment cools the system control unit by allowing the air generated from the cooling fan to contact the system control unit. The temperature of the air sent from the cooling fan increases due to the heat transmitted from the control substrate when the system control unit is cooled. The air having an increased temperature after cooling the system control unit is supplied to the heating mechanism through the duct as the air stream formed by the cooling fan. The heating mechanism heats the supplied air up to the temperature of the drying air. That is, the heating mechanism gives heat to the air receiving thermal energy from the system control unit so that the temperature of the air becomes equal to the temperature of the drying air. The air heated by the heating mechanism is discharged from the discharge opening as the air stream formed by the cooling fan.

That is, the image forming apparatus generates the drying air by heating the air used to cool the system control unit, and blows the generated drying air from the discharge opening to the image forming medium stacked on the paper discharge tray. With such a configuration, according to the embodiment, the air warmed by the thermal energy from the system control unit when the system control unit is cooled may be used as the drying air. That is, according to the embodiment, an increase in the amount of heat and consumption of power of the heating mechanism used to heat the air may be suppressed as much as the amount in which the air is warmed by the system control unit 17.

Further, in the image forming apparatus of the embodiment, the suction fan sucks the air in the periphery of the paper discharge tray from the suction hole provided in the paper discharge tray, and the sucked air is made to flow backward in front of the heating mechanism through the reflux duct. The air sucked from the suction hole provided in the paper discharge tray is the air discharged as the drying air from the discharge opening, and is controlled so that its temperature becomes equal to a desired temperature when the air is discharged from the discharge opening. That is, the air in the periphery of the paper discharge tray includes the air blown as the drying air to the image forming medium. The drying air is the air warmed by the heating mechanism, and the temperature of the air is higher than the ambient temperature in the periphery of the casing although the temperature of the air decreases due to the drying of the image forming medium. Accordingly, the air sucked from the suction hole is the air having a temperature higher than that of the ambient temperature in the periphery of the casing. According to the embodiment, since the high-temperature air blown as the drying air to the image forming medium is made to flow backward to the heating mechanism, an increase in the consumption of power of the entire image forming apparatus may be suppressed.

Further, in the image forming apparatus of the embodiment, the temperature of the drying air is set in accordance with the state of the image to be printed on the image forming medium (for example, the amount of ink). The air heated up to the set temperature in accordance with the amount of ink is blown to the image forming medium stacked on the paper discharge tray 40 through the discharge opening 41. Accordingly, according to the embodiment, the air having a temperature in accordance with the amount of ink may be made to contact the paper on the paper discharge tray, the drying of the ink on the image forming surface of the image forming medium may be promoted, and an increase in the consumption of power may be also suppressed. Further, according to the embodiment, the air having a temperature in accordance with the amount of ink may be used to dry the ink on the paper surface, and deformation of the image forming medium such as curling or cockling of the paper as the image forming medium may be suppressed.

For example, when the amount of ink discharged to the paper is small, moisture contained in the paper is also dried, so that curling of the paper occurs. If the amount of ink used to print an image on the paper is small (for example, when the density of the image is low and the printing area of the image is small), the CPU 70 sets the temperature of the drying air to be low. Accordingly, the air having a temperature in accordance with the amount of ink used for printing may be blown to the paper on the paper discharge tray, and deformation of the paper caused by excessively high-temperature air may be prevented or an increase in the consumption of power may be suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit which forms an image on an image forming medium;
a tray which stacks the image forming medium, having an image formed thereon by the image forming unit, on a tray;
a heating mechanism which warms air;
a blower which sends out the air warmed by the heating mechanism; and
a body casing which has a discharge opening used to discharge the air sent from the blower to the image forming medium stacked on the tray.

2. The apparatus according to claim 1, wherein the image forming unit forms an image on one surface of the image forming medium by ink.

3. The apparatus according to claim 2, wherein the discharge opening is provided at the side of a surface having an image formed in the image forming medium stacked on the tray.

4. The apparatus according to claim 2, further comprising:
a duct which is connected to the discharge opening,
wherein the blower is provided inside the duct.

5. The apparatus according to claim 4, further comprising:
a system control unit which is provided inside the duct.

6. The apparatus according to claim 2, further comprising:
a reflux duct which has a suction opening sucking air in the periphery of the tray.

7. The apparatus according to claim 6, wherein the reflux duct is connected to the duct.

8. The apparatus according to claim 7, wherein the reflux duct is connected to the duct between the blower and the heating mechanism.

9. The apparatus according to claim 8, further comprising:
a second blower which sucks air from a hole of the tray and to merge the sucked air with an air passage from the blower to the discharge opening.

10. The apparatus according to claim 2, further comprising:
a controller which controls the amount of heat generated by the heating mechanism in accordance with the contents of the image to be formed on the image forming medium.

11. The apparatus according to claim 10, wherein the control unit controls the amount of heat generated by the heating mechanism in accordance with the density of the image to be formed on the image forming medium.

12. The apparatus according to claim 10, wherein the control unit controls the amount of heat generated by the heating mechanism in accordance with the area of the image to be formed on the image forming medium.

13. The apparatus according to claim 1, further comprising:
a controller which controls the amount of heat generated by the heating mechanism in accordance with the contents of the image to be formed on the image forming medium.

14. The apparatus according to claim 13, wherein the control unit controls the amount of heat generated by the heating mechanism in accordance with the density of the image to be formed on the image forming medium.

15. The apparatus according to claim 13, wherein the control unit controls the amount of heat generated by the heating mechanism in accordance with the area of the image to be formed on the image forming medium.

16. A drying method in an image forming apparatus, comprising:
warming air by a heating mechanism;
stacking an image forming medium having an image formed thereon on a tray; and
blowing the warmed air to the image forming medium stacked on the tray.

17. The method according to claim 16, wherein in the image forming, an image is formed on one surface of the image forming medium by ink.

18. The method according to claim 17, wherein in the blowing, the warmed air is blown to the surface having an image formed in the image forming medium stacked on the tray.

19. The method according to claim 17, further comprising:
controlling the temperature of the air blown to the image forming medium to become a drying temperature in accordance with the density of the image formed on the image forming medium.

20. The method according to claim 17, further comprising:
controlling the temperature of the air blown to the image forming medium to become a drying temperature in accordance with the area of the image formed on the image forming medium.

21. The method according to claim 16, further comprising:
controlling the temperature of the air blown to the image forming medium to become a drying temperature in accordance with the density of the image formed on the image forming medium.
